(19) United States
(12) Patent Application Publication
(10) Pub. No.: US 2003/0190401 A1
(43) Pub. Date: Oct. 9, 2003

(54) Soy protein concentrate with low non-digestible oligosaccharides and process for its production

(76) Inventor: Navpreet Singh, Fort Wayne, IN (US)

Correspondence Address: BAKER & DANIELS, 111 E. WAYNE STREET, SUITE 800, FORT WAYNE, IN, 46802

(21) Appl. No.: 10/386,632

(22) Filed: Mar. 12, 2003

Related U.S. Application Data
(60) Provisional application No. 60/364,167, filed on Mar. 13, 2002.

(51) Int. Cl. A23L 2/38

(52) U.S. Cl. 426/598

(57) ABSTRACT

A soy protein concentrate having desirable flavor and functional properties, which is low in non-digestible oligosaccharides. The soy protein concentrate is substantially free of galactinol, a component which is present in soybeans which are developed to have a low non-digestible oligosaccharide content. The soy protein concentrate is also rich in isoflavones and also has a high Chymotrypsin Inhibitor (“CI”) content. The method for manufacturing the soy protein concentrate uses an enzyme such as a glycosidase enzyme, and retains the natural level of isoflavones occurring in soybeans.

### CROSS-REFERENCE TO RELATED APPLICATIONS

This application claims the benefit under Title 35, U.S.C. § 119(e) of U.S. Provisional Patent Application Serial No. 60/364,167, entitled SOY PROTEIN CONCENTRATE AND PROCESS FOR ITS MANUFACTURE, filed on Mar. 13, 2002.

### BACKGROUND OF THE INVENTION

1. Field of the Invention

The present invention relates to a soy protein concentrate with a modified sugar profile, and a method for producing same.

2. Description of the Related Art

The benefits of soy protein are well documented. Cholesterol is a major concern with consumers throughout the industrialized world. It is well known that vegetable products contain no cholesterol. For decades, nutritional studies have indicated that the inclusion of soy protein in the diet actually reduces serum cholesterol levels in people who are at risk. The higher the cholesterol, the more effective soy proteins are in lowering that level.

Soybeans have the highest protein content of all cereals and legumes with around 40 wt. % protein, while other legumes have 20-30 wt. %, and cereals have about 8-15 wt. % protein. Soybeans also contain about 20.0 wt. % oil, and the remaining dry matter is mostly carbohydrate (35.0 wt. %). In the soybean, both protein and lipid bodies are contained in the usable meat of the soybean, called the cotyledon. The complex carbohydrate (dietary fiber) is also contained in the cell walls of the cotyledon. The outer layer of cells (the seed coat) makes up about 8.0 wt. % of the soybean's total weight. A typical raw soybean includes approximately 18.0 wt. % oil, 15.0 wt. % soluble carbohydrates, 15.0 wt. % insoluble carbohydrates, 14.0 wt. % moisture and ash, and 38.0 wt. % protein.

In processing, soybeans are carefully selected for color and size. The soybeans are then cleaned, conditioned (to make removal of the hull easier) and cracked, dehulled, and then rolled into flakes. The flakes are subjected to a solvent bath that removes the oil. The solvent is removed and the flakes are dried, creating the defatted soy flakes that are the basis of all soy protein products. Despite the large number of products on the market, same are classified into three types of soy protein products: flours, concentrates and isolates.

Soy flours are the simplest forms of soy protein, with a protein content of approximately 50.0 wt. %. Soy flours are produced by simply grinding and screening the defatted flakes.

Soy flours are high in oligosaccharides, the soluble carbohydrates that give soy flours the “beany” flavor that some people find objectionable. The simple processing leaves the soy flour with many of the soybean's natural characteristics. However, the lack of processing also makes soy flours highly variable in terms of quality.

Soy flours and grits are still widely produced and are used most often in baked goods, snack foods and pet foods applications where the high flavor profile does not pose a problem. Textured soy flours were an early attempt at simulating or enhancing the texture of meat products. Texturizing does not change the composition of soy flours and reduces the flavor profile only slightly. Their primary applications are inexpensive meat products or pet foods.

Soy concentrates have at least 65.0 wt. % protein. A myriad of applications have been developed for soy concentrates and texturized concentrates in processed foods, meat, poultry, fish, cereal and dairy systems. Soy concentrates are made by removing soluble carbohydrate material from defatted soy meal. Aqueous alcohol extraction (60-80% ethanol) or acid leaching (at the isoelectric pH 4.5 of the protein) are the most common means for carbohydrate removal.

Isolates are produced through standard chemical isolation, drawing the protein out of the defatted flake through solubilization (alkali extraction at pH 7-10) and separation followed by isoelectric precipitation. As a result, isolates are 90.0 wt. % protein on a moisture-free basis. Isolates can be made with a high percentage of soluble protein and a low flavor profile. Isolates contain no dietary fiber and are sometimes high in sodium, properties that can limit their application. Isolate processing is relatively complex and the cost of isolates is high. Their major applications have been in dairy substitution, as in infant formulas and milk replacers.

The oligosaccharides raffinose and stachyose in soy flour and concentrates which are made from naturally occurring soybeans potentially cause flatulence as their bacterial fermentation in the colon creates intestinal gas, and are therefore not desirable in soy products. However, non-naturally occurring soybeans, which are genetically modified or otherwise specially developed to have a low non-digestible oligosaccharide content, include galactinol, which has many of the non-desirable properties of non-digestible oligosaccharides. Therefore, the potential digestibility benefits of these “low oligosaccharide” soybeans might be negated by the presence of galactinol in the soybean. Naturally occurring, i.e., non-modified, soybeans do not include galactinol.

Also, in recent years, research has been conducted to better understand the role of isoflavones, which naturally occur in soybeans, in chronic disease prevention. According to the American Institute for Cancer Research, isoflavones may inhibit enzymes necessary for the growth and the spread of many types of cancer such as breast cancer, prostate cancer and colon cancer. Isoflavones also have shown great promise in preventing osteoporosis and treating menopausal symptoms.

Bowman-Birk Inhibitor Concentrate (“BBIC”) has been shown to exhibit inhibitory activity against the malignant transformation of cells under certain conditions and its administration has been shown to affect various forms of cancer.

In particular, it has been shown that the enzyme-inhibitor described by Bowman (Proc. Soc. Expd. Med., 63:547 (1946)) and Birk et al. (Bull. Res. Council Israel, Sec. A 11:48 (1962) and Biochim. Biophys Acta, 67:326 (1963)), which is found in soybeans and is subsequently referred to as the Bowman-Birk Inhibitor (“BBI”), can prevent, or greatly reduce, radiologically or chemically induced malignant transformation of cells in culture and in experimental animals.

### SUMMARY OF THE INVENTION

The present invention provides a soy protein concentrate having desirable flavor and functional properties, which is low in non-digestible oligosaccharides. The soy protein concentrate is substantially free of galactinol, a component which is present in soybeans which are developed to have a low non-digestible oligosaccharide content. The soy protein concentrate is also rich in isoflavones and also has a high Chymotrypsin Inhibitor (“CI”) content. The method for manufacturing the soy protein concentrate uses an enzyme such as a glycosidase enzyme, and retains the natural level of isoflavones occurring in soybeans.

In one embodiment, a soy protein concentrate is provided, having a protein content of at least about 65.0 wt. % of total dry matter, less than about 4.0 wt. % non-digestible oligosaccharides (raffinose and stachyose) of total dry matter, less than about 2.0 wt. % crude fiber of total dry matter, and being substantially free of galactinol. The soy protein concentrate also may include at least about 2.0 mg/g isoflavones of total dry matter, and have a CI content of at least about 100 mg/g. The soy protein concentrate also has a Nitrogen Solubility Index (“NSI”) of at least about 70.

Also, a method for manufacturing a protein concentrate is provided, including the steps of providing a substantially defatted soybean material; treating the material with an enzyme at an effective temperature, time, and pH; removing fiber from the material before or after the enzyme treatment; inactivating the enzyme after the treatment; and reducing the amount of carbohydrates by ultrafiltration in order to achieve less than 4.0 wt. % non-digestible oligosaccharides of total dry matter in the concentrate and at least 65.0 wt. % protein of total dry matter in the concentrate. The concentrate is then used in a liquid or dry beverage, food or nutritional product.

In this manner, a novel soy protein concentrate with a modified sugar profile is produced from soybeans of the type conventionally grown by farmers and used by soybean processors. The modified sugar profile results in desirable flavor and functional properties. The resulting soy protein concentrate is low in non-digestible oligosaccharides.

The production process may be controlled to achieve a desired, reduced oligosaccharide content. In particular, it was discovered that the sucrose and non-digestible oligosaccharide content of the soy protein concentrate could be controlled in an economically efficient manner by using an enzyme that hydrolyzes stachyose and raffinose to generate glucose, galactose, fructose and sucrose.

The soy protein concentrate is substantially free of galactinol and has a low crude fiber content. It is believed that galactinol, or hydrogenated galactose, causes intestinal gas by fermentation in the colon.

The soy protein concentrate is also rich in isoflavones. In recent years, isoflavones have been researched extensively to better understand their role in chronic disease prevention. Isoflavones may inhibit enzymes necessary for the growth and spread of many types of cancer, such as breast cancer, prostate cancer and colon cancer. Isoflavones are also showing great promise in preventing osteoporosis and treating menopausal symptoms. Isoflavones are largely unaffected by the present water extraction process and therefore, isoflavones are retained in the present method at naturally occurring levels found in soybeans.

In one form thereof, the present invention provides a soy protein concentrate, including a protein content of at least 65.0 wt. % of total dry matter; a combined raffinose and stachyose content of less than about 4.0 wt. % of total dry matter; a crude fiber content of less than about 2.0 wt. % of total dry matter; and being substantially free of galactinol.

In another form thereof, the present invention provides a method for producing a soy protein concentrate, comprising the steps of: (a) providing a substantially defatted soybean material; (b) mixing the material with water to form a slurry; (c) treating the slurry with an enzyme; (d) removing fiber from the slurry to provide a liquor; (e) inactivating the enzyme; and (f) removing carbohydrates and minerals by subjecting the liquor to ultrafiltration to provide a retentate.

The method further includes before the treating step (c), the additional step of removing fiber from the slurry to provide liquor. Alternatively, the method may include, after the inactivating step (d), the additional step of removing fiber from the slurry to provide liquor.

Optionally, after the removing step (e), the method may include the additional step of (f) drying the retentate to provide a soy protein concentrate. The method may also include, prior to the drying step (f), the additional step of concentrating the retentate by removal of water therefrom.

### DETAILED DESCRIPTION

A soy protein concentrate is provided having at least 65.0 wt. % protein of total dry matter, less than about 4.0 wt. % non-digestible oligosaccharides (raffinose and stachyose) of total dry matter, less than about 2.0 wt. % crude fiber of total dry matter, and being substantially free of galactinol. Further, the soy protein concentrate may have a combined fructose, glucose, galactose and sucrose content of greater than about 5.0% of total dry matter.

The soybeans used in the present process are conventional soybeans which do not contain galactinol, a metabolic intermediate which is completely converted to raffinose and stachyose. Galactinol accumulates in soybeans which are genetically modified to contain high sucrose and low levels of raffinose and stachyose due to the absence of converting enzymes. Galactinol levels in modified soybeans are, typically, about the molar equivalent of raffinose and stachyose in conventional soybeans.

A method for manufacturing a protein concentrate is provided, including the steps of providing a substantially defatted soybean material; treating the material with an enzyme at an effective temperature and pH for an effective time; removing fiber from the material before or after the enzyme treatment; inactivating the enzyme after the enzyme treatment; and reducing the amount of carbohydrates by ultrafiltration in order to achieve less than 4.0 wt. % non-digestible oligosaccharides of total dry matter in the concentrate and at least 65.0 wt. % protein of total dry matter in the concentrate. The concentrate is then used in a liquid or dry beverage, food or nutritional product.

Generally, the present method encompasses: 1) dehulling whole soybeans; 2) flaking the dehulled soybeans; 3) extracting soybean oil from the flaked soybeans with a suitable solvent, such as hexane; 4) desolventizing the defatted soybean flakes without high heating or toasting to produce “white” flakes; 5) grinding the flakes to make soy flour; 6) removing fiber from the soy flour and hydrolyzing stachyose and raffinose in the soy flour with an enzyme and then inactivating the enzyme 7) ultrafiltering the liquor (fiber-removed slurry) to remove carbohydrates, and 8) drying the liquor.

Steps 1 through 5 described above are commonly referred to as the extraction process for soybeans. The general procedure for the above-described steps 1 through 5 is well understood, as described in U.S. Pat. No. 5,097,017 to Konwinski, assigned to the assignee of the present invention, the disclosure of which is expressly incorporated herein by reference.

The first item described above is dehulling. Dehulling is the process in which the soybean hulls are removed from the whole soybeans. The soybeans are carefully cleaned prior to dehulling to remove foreign matter, so that product will not be contaminated by color bodies. Soybeans also are normally cracked into about 6 to 8 pieces prior to dehulling.

The hull typically accounts for about 8.0 wt. % of the weight of the whole soybean. The dehulled soybean is about 10.0 wt. % water, 40.0 wt. % protein, 20.0 wt. % fat, with the remainder mainly being carbohydrates, fiber and minerals.

The second step described above is the flaking process. Soybeans are conditioned prior to flaking by adjusting moisture and temperature to make the soybean pieces sufficiently plastic. The conditioned soybean pieces are passed through flaking rolls to form flakes about 0.01 to 0.012 inches (in.) thick.

The third step described above is soybean oil removal from the flakes. The soybean flakes are defatted by contacting them with a solvent, such as hexane, to remove the soybean oil. The soybean oil is used in many applications, such as margarine, shortening and other food products, and is a good source of lecithin, which has many useful applications as an emulsifier.

In the fourth step described above, the defatted soybean flakes are desolventized to remove the hexane without toasting, producing white flakes.

In the fifth step described above, the white flakes are ground to make soy flour. Soy flour that can be used as a starting material for the subject invention is readily, commercially available. Commercial soy flour typically has at least 50.0 wt. % (52.5 wt. %) protein (N×6.25); about 30.0 to 40.0 wt. % (34.6 wt. %) carbohydrates; about 5.0 to 10.0 wt. % (6.0 wt. %) moisture; about 5.0 to 10.0 wt. % (6.0 wt. %) ash; about 2.0 to 3.0 wt. % (2.5 wt. %) crude fiber and less than about 1.0 wt. % (0.9 wt. %) fat (as determined by ether extraction).

The soy flour may have a protein dispersibility index (PDI) of 90. PDI is determined by American Oil Chemist's Society (AOCS) method Ba 10-65. Soy flour having 90 PDI would be soy flour with no heat treatment and is enzyme active. The soy flour may be 80-mesh, which means that more than 95 wt. % of the soy flour passes through a number 80 mesh USA standard sieve.

According to one embodiment of the present invention, the starting material which can be soy flour or soy flakes is produced according to a separate process such as described in steps 1-5 above, and provided for use in the following steps. Soy flour or soy flakes with protein dispersibility index of greater than 90% are commercially available from several companies.

The next steps include treating the soy flour with an enzyme and removing fiber from the material. Notably, fiber may be removed from the material either before or after enzyme treatment. In either case, the starting material is first preferably slurried with water. The water may be pre-heated to a temperature of from about 26° C. to about 66° C., and the slurry may include from about 5.0 wt. % to about 20.0 wt. % solids. Agitation or mixing is typically used to slurry the starting material. One means for performing the mixing is by using a propeller-type agitator, though other methods are also suitable.

The slurry is then treated with an enzyme at an effective temperature and pH for an effective time, as described below, to achieve less than 4.0 wt. % non-digestible oligosaccharides of total dry matter in the soy protein concentrate.

One suitable enzyme is a glycosidase enzyme, such as Novo Nordisk A/S Alpha-Gal 1000, present in an amount of about 450-2300 galactosidase units per pound of starting material, which is about 0.001-0.005 pounds of the enzyme in its liquid form per pound of starting material. The enzyme's activity of galactosidase units per gram is determined by Novo Nordisk's analytical method.

Alpha-Gal 1000 is a single activity enzyme that hydrolyses only stachyose and raffinose to generate galactose and sucrose, and the enzyme is effective in the pH range of from 3.5 to 6.5. Another suitable enzyme is alpha-galactosidase, made by the Amano Company. Both enzymes will achieve complete conversion of stachyose and raffinose at ambient temperature given suitable reaction time.

Another suitable enzyme is the alpha-galactosidase enzyme Validase AGS (in solid powder form) or Validase AGSL (in liquid form), manufactured by Valley Research, Inc., South Bend, Ind. This alpha-galactosidase enzyme is a carbohydrase enzyme which is able to hydrolyze alpha 1-6 linkages in raffinose, stachyose, and also in melibiose.

Generally, suitable enzymes may include or lack invertase activity, as desired. An enzyme which lack invertase activity will hydrolyze both stachyose and raffinose to generate sucrose. An enzyme which includes invertase activity will also hydrolyze both stachyose and raffinose to generate sucrose, yet will also hydrolyze sucrose to generate glucose.

The effective time duration for the enzyme treatment is between about 1 and about 4 hours, preferably between about 1 and about 3 hours. The effective temperature of the slurry for the enzyme treatment is between about 20.0° C. and about 63.0° C., preferably between about 55.0° C. and about 63.0° C. The effective pH of the slurry for the enzyme treatment is between about 6.0 and about 6.5, preferably between about 6.0 and about 6.3. One means for reaching the effective pH is to adjust the pH of the slurry with hydrochloric acid.

The effective time can be controlled to achieve a desired level of non-digestible oligosaccharides in the soy protein concentrate. For example, if the effective time duration of treatment with the enzyme is controlled between about 1 and about 2 hours, the concentrate usually will have less than about 1.5 wt. % stachyose of total dry matter and less than about 2-3 wt. % raffinose of total dry matter.

After the enzyme treatment, the enzyme is deactivated to terminate the activity of the enzyme and halt the hydrolysis reaction. One means for enzyme deactivation is pasteurization of the slurry at temperature of about 80.0° C. and above. Pasteurization may be carried out by jet cooking or by holding in a steam-jacketed kettle. The enzyme deactivation/pasteurization is performed so that the product also tests negative for salmonella and has an acceptable microbial profile.

The next operation is fiber removal. Again, the fiber removal may be performed either before or after the enzyme treatment. One means for removing fiber is adjusting the pH of the slurry to between about 7 and about 7.5, most preferably about 7.4, using sodium hydroxide. The slurry is then separated or clarified to form a cake and a liquor. The separation/clarification can be performed by a number of physical separation means; however, centrifugation is typically the most efficient and effective means. A scroll-type centrifuge may be used to perform the separation, or the separation can be performed with a disc-type or tubular centrifuge.

The enzyme-treated, fiber-removed material (the liquor) is then ultrafiltered using a 1,000 to 300,000 molecular weight cut-off (“MWCO”) membrane, preferably a 1,000-60,000 MWCO membrane to achieve a protein content of at least 65.0 wt. % protein of total dry matter in the concentrate, more preferably a protein content of at least 70.0 wt. % protein of total dry matter. The ultrafiltration membrane concentrates the protein content of the liquor in the retentate by permeating carbohydrates and minerals in permeate. Also, the protein content of the product may be controlled based upon the amount of permeate removed from the product by ultrafiltration—the more permeate removed, the higher the protein content, and the less permeate removed, the lower the protein content. Suitable membranes of varying MWCO are readily commercially available from several vendors, such as Koch Membrane Systems of Wilmington, Mass.; Osmonics of Minnetonka, Minn.; PTI Advanced Filtration of Oxnard, Calif.; and Snyder Filtration of Vacaville, Calif.

In the ultrafiltration step, isoflavones are retained in the retentate. Isoflavones are small molecular weight components, having a molecular weight of less than 1,500. Although it might be expected that isoflavones would pass through the membrane along with carbohydrates and minerals in the permeate, it has surprisingly been found that isoflavones are retained by the ultrafiltration membranes in the retentate. It is believed at this time that the isoflavones might complex with the proteins such that the majority of the isoflavones are retained in the retentate.

Typically, about 25% of the feed volume is removed as permeate during the ultrafiltration, resulting in a retentate product having a protein content of at least about 65.0 wt. % of total dry matter. Preferably, the product contains protein at about 70 to 85 wt. % of total dry matter.

The enzyme-treated, fiber-removed, and ultrafiltered material (the retentate) is dried to form the soy protein concentrate. Drying may be carried out with a vertical spray dryer with a high-pressure nozzle, for example.

The enzyme-treated, fiber-removed, and ultrafiltered retentate may optionally be concentrated prior to the drying step. The concentration may be performed by a reverse osmosis membrane concentration or by evaporation unit operations. A benefit of concentrating the liquor prior to drying is that drying costs are reduced.

The dried protein concentrate may be coated with commercial lecithin or other food-grade surfactants, such as mono-diglycerides, to improve water dispersibility and reduce clumping of the concentrate. Such a coating addition is typically at a level of between about 0.5 wt. % and about 1.0 wt. %.

The concentrate has many uses. For example, it can be used as a milk replacer and in drink mixes and beverages, such as chocolate, vanilla and pineapple beverages; dairy products, such as fruit yogurt; nutrition and health products, such as protein bars; whole muscle meat injection; surimi products; emulsified meats; cereal products, such as breakfast cereals; bakery products, such as blueberry muffins and other liquid or dry beverage, food or nutritional products.

In the Examples below, Nitrogen Solubility Index (“NSI”) was measured according to American Oil Chemists' Method Ba 11-65. NSI characterizes the amount of protein in the product which is water-soluble, for example, a protein product having an NSI of 75 means that 75 wt. % of the protein therein is water-soluble.

Also, in the Examples below, isoflavones were characterized by the procedure described in Thiagarajan, D. G., Bennink, M. R., Bourquin, L. D., and Kavas, F. A., Prevention of precancerous colonic lesions in rats by soy flakes, soy flour, genistein, and calcium, Am. J. Clin. Nutr. 1998; 68(suppl.); 1394S-9S.

The fiber-removed, ultrafiltered material (the retentate) can be dried to form a high protein content Bowman-Birk Inhibitor (“BBI”) concentrate. The amount of BBI in the product is characterized by the presence of Chymotrypsin Inhibitor (“CI”), which is an indirect assay for BBI. The method used for CI analysis is based on the American Oil Chemists' Society (AOCS) official method Ba-12-75 for trypsin inhibitor activity for soy products, differing in the enzyme and substrate used. The substrate used for CI analysis is N-Glutaryl-LPhenylaianine-p-nitroanilide (GPNA), available from Sigma Chemicals as 62505. The enzyme used is L-Chymotrypsin, Type II—Bovine pancreatic alpha chymotrypsin, available from Sigma Chemicals as C4129. The AOCS method is based upon Kakade et al. (Cereal Chemistry, 51. 376 (1974)).

Chymotrypsin hydrolyzes the substrate glutaryl-L-phenylalanine-p-nitroanilide present in excess. The release of p-nitroanilide, a yellow dye, is measured spectrophotometrically. In the presence of soy protein product, the release of p-nitroanilide changes inversely with the level of active chymotrypsin inhibitor.

These and other aspects of the present invention may be more readily understood by reference to one or more of the following examples.

### EXAMPLE 1

261.7 kg (577 pounds (lbs.)) of water were added to a mixing tank at 60° C. 22.7 kg (50 lbs.) of soy white flakes were added. The pH was adjusted to 6.0 with hydrochloric acid. 22.7 gram (g) of Validase AGS enzyme were added. The slurry was mixed for 2 hours (hrs.) at 60° C. The pH of the enzyme treated slurry was adjusted to 7.0 with 5% sodium hydroxide. The enzyme treated, pH adjusted slurry was fed at the rate of 7.6 L per minute (2 gallons per minute, GPM) to a Sharples scroll-type centrifuge. The liquor was jet cooked at 121° C. The jet-cooked liquor was fed to an ultrafiltration membrane system having a 10,000 MWCO membrane. 25% of the original feed volume was removed as permeate. The retentate from the membrane system was spray dried using a high-pressure pump feeding a spray nozzle. Sugar analysis was conducted on the spray-dried powder by the method of Shukla, Fett Wissenschaft Technologie, 89(2), pp. 75-79 (1987).

The soy protein concentrate had 67.1 wt. % crude protein; 0.9 wt. % crude fiber; 0.1 wt. % crude fat and 9.7 wt. % ash of the total dry matter. The concentrate had 3.1 wt. % non-digestible oligosaccharides (stachyose, raffinose, and melibiose) of total dry matter. The concentrate had 12.9 wt. % monosaccharides and 2.0 wt. % sucrose of total dry matter. The concentrate had 4190 microgram isoflavones per gram of dry matter.

### EXAMPLE 2

176.9 kg (390 pounds (lbs.)) of water were added to a mixing tank at 60.0° C. 22.7 kg (50 lbs.) of soy white flakes were added. The pH was adjusted to 6.0 with hydrochloric acid. 22.7 gram (g) of Validase AGS enzyme were added. The slurry was mixed for 2 hours at 60° C. The pH of the enzyme treated slurry was adjusted to 7.0 with 5% sodium hydroxide. 84.8 kg (187 lbs.) of water pre-heated to 60.0° C. was added. The enzyme treated, pH adjusted slurry was fed at the rate of two gallons per minute (GPM) to a Sharples scroll-type centrifuge. The liquor was jet cooked at 121.0° C. The jet-cooked liquor was fed to an ultrafiltration membrane system having a 10,000 MWCO membrane. 75% of the original feed volume was removed as permeate. The retentate from the membrane system was spray dried using a high-pressure pump feeding a spray nozzle. The dried product was analyzed to determine the content thereof. The results of the analysis are shown in TABLE 1. All results are on moisture-free basis, unless otherwise stated.

TABLE 1
Composition of product derived from the method of EXAMPLE 2

| | | | mg/g | |
|---|---|---|---|---|
| Composition | | wt. % | of total dry matter | |
| Protein | | 86.66 | | |
| Crude Fiber | | 0.31 | | |
| Crude Fat | | 0.01 | | |
| Ash | | 5.41 | | |
| Fructose | | | 23.54 | |
| Glucose/Galactose | | | 26.46 | |
| Sucrose | | | 6.69 | |
| Raffinose | | | 4.56 | |
| Stachyose | | | 3.69 | |
| Isoflavones | | | 3.41 | |
| | Daidzin | | | 0.44 |
| | Glycitin | | | 0.11 |
| | Genistin | | | 0.59 |
| | 6″-O-malonyldaidzin | | | 0.73 |
| | 6″-O-malonylglycitin | | | 0.12 |
| | 6″-O-acetyl genistin | | | 0.08 |
| | 6″-O-malonylgenistin | | | 1.03 |
| | Daidzein | | | 0.16 |
| | Genistein | | | 0.15 |

### EXAMPLE 3

An application of the soy protein concentrate made in Example 1 is a soymilk having 6.25 g of soy protein in a 24 g serving. A formula for such a beverage contains: 808.2 g water (80.82 wt. %); 62 g sucrose (6.2 wt. %); 42.4 g soy protein product (4.24 wt. %); 38.6 g Cerestar USA, Inc. C*MD 01960 maltodextrin (3.86 wt. %); 27 g Cerestar USA C*DRY GL 01925 corn syrup (2.7 wt. %); 12 g gum arabic (1.2 wt. %); 5 g Central Soya Company, Inc. soybean oil (0.5 wt. %); 2.5 g Central Soya CENTROLEX® F lecithin (0.25 wt. %); 1.8 g Na citrate (0.18 wt. %); 0.3 g Na phosphate dibasic (0.03 wt. %) and 0.02 wt. % antifoam agents. The dry ingredients are blended; pre-heated (60.0° C.) water added; antifoam added; high shear mixed/homogenized (2500 PSIG) and treated at ultra high temperature (141.0° C.) for 5 seconds.

The finished product was stable at neutral pH and had a good flavor similar to commercial soymilks. The most noticeable improvement in the product was in the mouthfeel. The beverage was smooth and free of grittiness compared to beverages made from currently available soy protein concentrates.

### EXAMPLE 4

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 300 ml of Validase AGSL enzyme was added to the centrifuge feed tank and the slurry was mixed for 2 hours while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing two spiral-wound membranes, both of 10,000 MWCO. The temperature of the suspension was maintained at about 26.7° C. during membrane processing. About 30% of the original feed volume added to the membrane feed tank was removed as permeate. The retentate from the membrane system was pasteurized at about 93.3° C. and spray dried using a high-pressure pump feeding a spray nozzle in a vertical spray dryer. The dried product was analyzed to determine the content thereof. The results of the analysis are shown in TABLE 2. All results are on moisture-free basis, unless otherwise stated.

TABLE 2
Composition of product derived from the method of EXAMPLE 4

| | | | mg/g | |
|---|---|---|---|---|
| Composition | | wt. % | of total dry matter | |
| Protein | | 70.51 | | |
| Crude Fiber | | 0.32 | | |
| Crude Fat | | 0.01 | | |
| Ash | | 8.60 | | |
| Fructose | | | 51.70 | |
| Glucose/Galactose | | | 41.00 | |
| Sucrose | | | 25.69 | |
| Raffinose | | | 14.34 | |
| Stachyose | | | 19.70 | |
| Isoflavones | | | 5.49 | |
| | Daidzin | | | 0.93 |
| | Glycitin | | | 0.18 |
| | Genistin | | | 1.03 |
| | 6″-O-malonyldaidzin | | | 1.21 |
| | 6″-O-malonylglycitin | | | 0.18 |
| | 6″-O-acetyl genistin | | | 0.15 |
| | 6″-O-malonylgenistin | | | 1.43 |
| | Daidzein | | | 0.19 |
| | Genistein | | | 0.19 |

| | | |
|---|---|---|
| Nitrogen Solubility Index (NSI) | 78.7 | |
| Chymotrypsin Inhibitor (CI) | | 128.2 |

### EXAMPLE 5

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 400 ml of Validase AGSL enzyme was added to the centrifuge feed tank and the slurry was mixed for 2 hours while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121.0° C. The jet-cooked suspension was flash cooled and transferred to a membrane feed tank through a 100-mesh strainer. The suspension was fed to an ultrafiltration membrane system containing two spiral-wound membranes, both of 10,000 MWCO. The temperature of the suspension was maintained at about 26.7° C. during membrane processing. About 35% of the original feed volume added to the membrane feed tank was removed as permeate. The retentate from the membrane system was pasteurized at about 93.3° C. and spray dried using a high-pressure pump feeding a spray nozzle in a vertical spray dryer. The dried product was analyzed to determine the content thereof. The results of the analysis are shown in TABLE 3. All results are on moisture-free basis, unless otherwise stated.

TABLE 3
Composition of product derived from the method of EXAMPLE 5

| | | | mg/g | |
|---|---|---|---|---|
| Composition | | wt. % | of total dry matter | |
| Protein | | 73.25 | | |
| Crude Fiber | | 0.87 | | |
| Crude Fat | | 0.11 | | |
| Ash | | 8.16 | | |
| Fructose | | | 54.78 | |
| Glucose/Galactose | | | 46.27 | |
| Sucrose | | | 12.77 | |
| Raffinose | | | 6.77 | |
| Stachyose | | | 5.78 | |
| Isoflavones | | | 5.64 | |
| | Daidzin | | | 0.95 |
| | Glycitin | | | 0.24 |
| | Genistin | | | 1.04 |
| | 6″-O-malonyldaidzin | | | 1.13 |
| | 6″-O-malonylglycitin | | | 0.21 |
| | 6″-O-acetyl genistin | | | 0.17 |
| | 6″-O-malonylgenistin | | | 1.34 |
| | Daidzein | | | 0.27 |
| | Genistein | | | 0.29 |

| | | |
|---|---|---|
| Nitrogen Solubility Index (NSI) | 65.6 | |
| Chymotrypsin Inhibitor (CI) | | 121.3 |

### EXAMPLE 6

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 800 ml of Validase AGSL enzyme was added to the centrifuge feed tank and the slurry was mixed for 1 hour while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing two spiral-wound membranes, both of 10,000 MWCO. The temperature of the suspension was maintained at about 49.0° C. during membrane processing. About 35% of the original feed volume added to the membrane feed tank was removed as permeate. The retentate from the membrane system was pasteurized at about 93.3° C. and spray dried using a high-pressure pump feeding a spray nozzle in a vertical spray dryer. The dried product was analyzed to determine the content thereof. The results of the analysis are shown in TABLE 4. All results are on moisture-free basis, unless otherwise stated.

TABLE 4
Composition of product derived from the method of EXAMPLE 6

| | | | mg/g | |
|---|---|---|---|---|
| Composition | | wt. % | of total dry matter | |
| Protein | | 70.83 | | |
| Crude Fiber | | 0.53 | | |
| Crude Fat | | 0.03 | | |
| Ash | | 8.42 | | |
| Fructose | | | 58.32 | |
| Glucose/Galactose | | | 65.13 | |
| Sucrose | | | 5.64 | |
| Raffinose | | | 7.56 | |
| Stachyose | | | 6.28 | |
| Isoflavones | | | 4.90 | |
| | Daidzin | | | 0.70 |
| | Glycitin | | | 0.15 |
| | Genistin | | | 0.78 |
| | 6″-O-malonyldaidzin | | | 1.12 |
| | 6″-O-malonylglycitin | | | 0.16 |
| | 6″-O-acetyl genistin | | | 0.11 |
| | 6″-O-malonylgenistin | | | 1.33 |
| | Daidzein | | | 0.26 |
| | Genistein | | | 0.29 |

| | | |
|---|---|---|
| Nitrogen Solubility Index (NSI) | 84.5 | |
| Chymotrypsin Inhibitor (CI) | | 131.6 |

### EXAMPLE 7

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 1600 ml of Validase AGSL enzyme was added to the centrifuge feed tank and the slurry was mixed for 1 hour while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing two spiral-wound membranes, both of 10,000 MWCO. The temperature of the suspension was maintained at about 49.0° C. during membrane processing. About 35% of the original feed volume added to the membrane feed tank was removed as permeate. The retentate from the membrane system was pasteurized at about 82.2° C. and spray dried using a high-pressure pump feeding a spray nozzle in a vertical spray dryer. The dried product was analyzed to determine the content thereof. The results of the analysis are shown in TABLE 5. All results are on moisture-free basis, unless otherwise stated.

TABLE 5
Composition of product derived from the method of EXAMPLE 7

| | | | mg/g | |
|---|---|---|---|---|
| Composition | | wt. % | of total dry matter | |
| Protein | | 69.93 | | |
| Crude Fiber | | 0.43 | | |
| Crude Fat | | 0.03 | | |
| Ash | | 8.43 | | |
| Fructose | | | 61.07 | |
| Glucose/Galactose | | | 65.76 | |
| Sucrose | | | 0 | |
| Raffinose | | | 2.56 | |
| Stachyose | | | 2.99 | |
| Isoflavones | | | 5.00 | |
| | Daidzin | | | 0.69 |
| | Glycitin | | | 0.15 |
| | Genistin | | | 0.75 |
| | 6″-O-malonyldaidzin | | | 1.20 |
| | 6″-O-malonylglycitin | | | 0.16 |
| | 6″-O-acetyl genistin | | | 0.11 |
| | 6″-O-malonylgenistin | | | 1.42 |
| | Daidzein | | | 0.25 |
| | Genistein | | | 0.27 |

| | | |
|---|---|---|
| Nitrogen Solubility Index (NSI) | 74.4 | |
| Chymotrypsin Inhibitor (CI) | | 133.8 |

### EXAMPLE 8

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 400 ml of Validase AGSL enzyme was added to the centrifuge feed tank and the slurry was mixed for 1 hour while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing two spiral-wound membranes, both of 10,000 MWCO. The temperature of the suspension was maintained at about 49.0° C. during membrane processing. About 35% of the original feed volume added to the membrane feed tank was removed as permeate. The retentate from the membrane system was pasteurized at about 82.2° C. and spray dried using a high-pressure pump feeding a spray nozzle in a vertical spray dryer. The dried product was analyzed to determine the content thereof. The results of the analysis are shown in TABLE 6. All results are on moisture-free basis, unless otherwise stated.

TABLE 6
Composition of product derived from the method of EXAMPLE 8

| | | | mg/g | |
|---|---|---|---|---|
| Composition | | wt. % | of total dry matter | |
| Protein | | 71.19 | | |
| Crude Fiber | | 1.06 | | |
| Crude Fat | | 0.12 | | |
| Ash | | 8.24 | | |
| Fructose | | | 47.26 | |
| Glucose/Galactose | | | 50.88 | |
| Sucrose | | | 36.51 | |
| Raffinose | | | 15.75 | |
| Stachyose | | | 17.03 | |
| Isoflavones | | | 5.30 | |
| | Daidzin | | | 0.77 |
| | Glycitin | | | 0.15 |
| | Genistin | | | 0.85 |
| | 6″-O-malonyldaidzin | | | 1.27 |
| | 6″-O-malonylglycitin | | | 0.18 |
| | 6″-O-acetyl genistin | | | 0.14 |
| | 6″-O-malonylgenistin | | | 1.53 |
| | Daidzein | | | 0.20 |
| | Genistein | | | 0.21 |

| | | |
|---|---|---|
| Nitrogen Solubility Index (NSI) | 78.6 | |
| Chymotrypsin Inhibitor (CI) | | 135.9 |

### EXAMPLE 9

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 400 ml of Validase AGSL enzyme was added to the centrifuge feed tank and the slurry was mixed for 2 hours while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing one spiral-wound membrane of 1,000 MWCO. The temperature of the suspension was maintained at about 49.0° C. during membrane processing. About 35% of the original feed volume added to the membrane feed tank was removed as permeate. The retentate from the membrane system was pasteurized at about 82.2° C. and spray dried using a high-pressure pump feeding a spray nozzle in a vertical spray dryer. The dried product was analyzed to determine the content thereof. The results of the analysis are shown in TABLE 7. All results are on moisture-free basis, unless otherwise stated.

TABLE 7
Composition of product derived from the method of EXAMPLE 9

| | | | mg/g | |
|---|---|---|---|---|
| Composition | | wt. % | of total dry matter | |
| Protein | | 72.38 | | |
| Crude Fiber | | 2.80 | | |
| Crude Fat | | 0.10 | | |
| Ash | | 8.44 | | |
| Fructose | | | 57.91 | |
| Glucose/Galactose | | | 68.78 | |
| Sucrose | | | 9.58 | |
| Raffinose | | | 9.90 | |
| Stachyose | | | 9.15 | |
| Isoflavones | | | 5.09 | |
| | Daidzin | | | 0.76 |
| | Glycitin | | | 0.16 |
| | Genistin | | | 0.82 |
| | 6″-O-malonyldaidzin | | | 1.19 |
| | 6″-O-malonylglycitin | | | 0.17 |
| | 6″-O-acetyl genistin | | | 0.15 |
| | 6″-O-malonylgenistin | | | 1.44 |
| | Daidzein | | | 0.20 |
| | Genistein | | | 0.20 |

| | | |
|---|---|---|
| Nitrogen Solubility Index (NSI) | 72.7 | |
| Chymotrypsin Inhibitor (CI, as-is) | | 119.3 |

### EXAMPLE 10

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 400 ml of Validase AGSL enzyme was added to the centrifuge feed tank and the slurry was mixed for 2 hours while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121.0° C. The jet-cooked suspension was flash cooled and transferred to a membrane feed tank through a 100-mesh strainer. The suspension was fed to an ultrafiltration membrane system containing one spiral-wound membrane of 60,000 MWCO. The temperature of the suspension was maintained at about 49.0° C. during membrane processing. About 35% of the original feed volume added to the membrane feed tank was removed as permeate. The retentate from the membrane system was pasteurized at about 82.2° C. and spray dried using a high-pressure pump feeding a spray nozzle in a vertical spray dryer. The dried product was analyzed to determine the content thereof. The results of the analysis are shown in TABLE 8. All results are on moisture-free basis, unless otherwise stated.

TABLE 8
Composition of product derived from the method of EXAMPLE 10

| | | | mg/g | |
|---|---|---|---|---|
| Composition | | wt. % | of total dry matter | |
| Protein | | 71.76 | | |
| Crude Fiber | | 1.08 | | |
| Crude Fat | | 0.06 | | |
| Ash | | 8.34 | | |
| Fructose | | | 53.20 | |
| Glucose/Galactose | | | 63.00 | |
| Sucrose | | | 14.43 | |
| Raffinose | | | 11.74 | |
| Stachyose | | | 11.95 | |
| Isoflavones | | | 5.08 | |
| | Daidzin | | | 0.83 |
| | Glycitin | | | 0.15 |
| | Genistin | | | 0.90 |
| | 6″-O-malonyldaidzin | | | 1.15 |
| | 6″-O-malonylglycitin | | | 0.16 |
| | 6″-O-acetyl genistin | | | 0.14 |
| | 6″-O-malonylgenistin | | | 1.38 |
| | Daidzein | | | 0.18 |
| | Genistein | | | 0.19 |

| | | |
|---|---|---|
| Nitrogen Solubility Index (NSI) | 72.7 | |
| Chymotrypsin Inhibitor (CI) | | 120.7 |

### EXAMPLE 11

About 247.7 kg (546 pounds (lbs.)) of water were added to a mixing tank and heated to 65.6° C. Then, about 31.8 kg (70 pounds) of soy flakes were added to the mixing tank to form slurry. The pH of the slurry was adjusted to about 6.0, using hydrochloric acid solution. The slurry was mixed for 10 minutes and then transferred to centrifuge feed tank. 400 ml of Validase AGSL enzyme was added to the centrifuge feed tank and the slurry was mixed for 2 hours while maintaining temperature at 60.0° C. The pH of the enzyme treated slurry was adjusted to 7.2 using about 10% sodium hydroxide solution. About 119.0 kg (262 lbs.) of water pre-heated to 62.8° C. was added to the centrifuge feed tank and mixed with the enzyme treated slurry. The diluted slurry was fed at a rate of about 7.6 L per minute (2 gallons per minute) to a Sharples scroll-type centrifuge. The supernatant (suspension) was jet cooked at a temperature of about 121° C. The jet-cooked suspension was flash cooled and transferred to a membrane feed tank through a 100-mesh strainer. The suspension was fed to an ultrafiltration membrane system containing two spiral-wound membranes, both of 30,000 MWCO. The temperature of the suspension was maintained at about 49.0° C. during membrane processing. About 35% of the original feed volume added to the membrane feed tank was removed as permeate. The retentate from the membrane system was pasteurized at about 82.2° C. and spray dried using a high-pressure pump feeding a spray nozzle in a vertical spray dryer. The dried product was analyzed to determine the content thereof. The results of the analysis are shown in TABLE 9. All results are on moisture-free basis, unless otherwise stated.

TABLE 9
Composition of product derived from the method of EXAMPLE 11

| | | | mg/g | |
|---|---|---|---|---|
| Composition | | wt. % | of total dry matter | |
| Protein | | 72.13 | | |
| Crude Fiber | | 0.54 | | |
| Crude Fat | | 0.09 | | |
| Ash | | 7.96 | | |
| Fructose | | | 51.99 | |
| Glucose/Galactose | | | 46.81 | |
| Sucrose | | | 7.55 | |
| Raffinose | | | 11.76 | |
| Stachyose | | | 14.02 | |
| Isoflavones | | | 4.99 | |
| | Daidzin | | | 0.79 |
| | Glycitin | | | 0.16 |
| | Genistin | | | 0.87 |
| | 6″-O-malonyldaidzin | | | 1.10 |
| | 6″-O-malonylglycitin | | | 0.14 |
| | 6″-O-acetyl genistin | | | 0.15 |
| | 6″-O-malonylgenistin | | | 1.32 |
| | Daidzein | | | 0.22 |
| | Genistein | | | 0.24 |

| | | |
|---|---|---|
| Nitrogen Solubility Index (NSI) | 69.2 | |
| Chymotrypsin Inhibitor (CI) | | 117.5 |

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A soy protein concentrate, comprising:
a protein content of at least 65.0 wt. % of total dry matter;
a combined raffinose and stachyose content of less than about 4.0 wt. % of total dry matter;
a crude fiber content of less than about 2.0 wt. % of total dry matter; and
being substantially free of galactinol.

2. The soy protein concentrate of claim 1, further comprising a combined fructose, glucose, galactose and sucrose content of greater than about 5.0 wt. % of total dry matter.

3. The soy protein concentrate of claim 1, further comprising an isoflavone content of at least 2.0 mg/g of total dry matter.

4. The soy protein concentrate of claim 1, wherein said protein content is between about 70.0 wt. % and about 75.0 wt. % of total dry matter.

5. The soy protein concentrate of claim 1, wherein said crude fiber content is less than about 1.0 wt. % of total dry matter.

6. The soy protein concentrate of claim 1, further comprising a Nitrogen Solubility Index (“NSI”) of greater than about 70.

7. The soy protein concentrate of claim 1, further comprising a Chymotrypsin Inhibitor (“CI”) content of at least 100 mg/g.

8. The concentrate of claim 1, wherein said soy protein content in said soy protein concentrate is not derived from low oligosaccharide soybeans.

9. A liquid or dry beverage, food or nutritional product comprising the soy protein concentrate of claim 1.

10. A method for producing a soy protein concentrate, comprising the steps of:
(a) providing a substantially defatted soybean material;
(b) mixing the material with water to form a slurry;
(c) treating the slurry with an enzyme;
(d) removing fiber from the slurry to provide a liquor;
(e) inactivating the enzyme; and
(f) removing carbohydrates and minerals by subjecting the liquor to ultrafiltration to provide a retentate.

11. The method of claim 10, further comprising, after said removing step (f), the additional step of (g) drying the retentate to provide a soy protein concentrate.

12. The method of claim 11, further comprising, prior to said drying step (g), the additional step of concentrating the retentate by removal of water therefrom.

13. The method of claim 10, wherein said step (d) of removing fiber from the slurry is performed before said treating step (c).

14. The method of claim 10, wherein said step (d) of removing fiber from the slurry is performed after said inactivating step (e).

15. The method of claim 10, wherein said the inactivating step (e) comprises pasteurization at a temperature of at least about 80.0° C.

16. The method of claim 10, wherein said mixing step (b) comprises slurrying the defatted soybean material in water at a level of between about 5.0 wt. % and about 20.0 wt. % solids.

17. The method of claim 10, wherein said treating step (c) comprises treating the slurry with an enzyme at a temperature of between about 20.0° C. and about 63.0° C.

18. The method of claim 10, wherein said treating step (c) comprises treating the slurry with an enzyme at a pH of between about 6.0 and about 6.5.

19. The method of claim 10, wherein said treating step (c) comprises treating the slurry with an enzyme for between about 1 and about 4 hours before performing said deactivating step (e).

20. The method of claim 10, wherein said treating step (c) comprises treating the slurry with alpha-glycosidase enzyme.

21. The method of claim 20, wherein the glycosidase enzyme is □-galactosidase.

22. The method of claim 10, wherein said removing step (f) comprises subjecting the slurry to ultrafiltration using a membrane having a molecular weight cutoff (“MWCO”) of between about 1,000 and about 60,000.

23. The method of claim 11, wherein the soy protein concentrate comprises a protein content of at least about 65.0 wt. % of total dry matter.

24. The method of claim 11, wherein the soy protein concentrate comprises a combined raffinose and stachyose content of less than about 4.0 wt. % of total dry matter.

25. The method of claim 11, wherein the soy protein concentrate comprises a crude fiber content of less than about 2.0 wt. % of total dry matter.

26. The method of claim 11, wherein the soy protein concentrate is substantially free of galactinol.

27. The method of claim 11, wherein the soy protein concentrate comprises an isoflavone content of at least about 2.0 mg/g of total dry matter.

28. The method of claim 11, wherein the soy protein concentrate comprises a Nitrogen Solubility Index (“NSI”) of greater than about 70.

29. The method of claim 11, wherein the soy protein concentrate comprises a Chymotrypsin Inhibitor (“CI”) content of at least 100 mg/g.

30. A liquid or dry beverage, food or nutritional product comprising the soy protein concentrate of claim 10.
